(19) United States
(12) Patent Application Publication
(10) Pub. No.: US 2026/0005397 A1
(43) Pub. Date: Jan. 1, 2026

(54) BATTERY SEPARATOR AND PREPARATION METHOD THEREFOR, AND BATTERY

(71) Applicant: SINOMA LITHIUM BATTERY SEPARATOR CO., LTD., Zaozhuang, Shandong (CN)

(72) Inventors: Gaojun LIU, Zaozhuang, Shandong (CN); Xiao TANG, Zaozhuang, Shandong (CN); Feifei GAO, Zaozhuang, Shandong (CN); Wenjuan QIN, Zaozhuang, Shandong (CN); Lin BAI, Zaozhuang, Shandong (CN); Jing SUN, Zaozhuang, Shandong (CN); Meng XU, Zaozhuang, Shandong (CN); Lei ZHENG, Zaozhuang, Shandong (CN); Yaozong BAI, Zaozhuang, Shandong (CN); Zhuxin CHU, Zaozhuang, Shandong (CN)

(21) Appl. No.: 18/864,183

(22) PCT Filed: Apr. 3, 2024
(86) PCT No.: PCT/CN2024/075249

§ 371 Date: Apr. 17, 2025

(30) Foreign Application Priority Data
Jun. 15, 2023 (CN) 202310711408.9

(51) Int. Cl. H01M 50/446; H01M 10/0525; H01M 50/403; H01M 50/42; H01M 50/434; H01M 50/443; H01M 50/451; H01M 50/489

(52) U.S. Cl. CPC H01M 50/446; H01M 10/0525; H01M 50/403; H01M 50/42; H01M 50/434; H01M 50/443; H01M 50/451; H01M 50/489

(57) ABSTRACT

The present application provides a battery separator and a preparation method therefor, and a battery. The battery separator provided by the present application comprises a base film and a coating coated on one or both sides of the base film, wherein the coating comprises: fluorine-free polymer resin particles and ceramic particles; wherein the fluorine-free polymer resin particles have a primary particle morphology or a secondary agglomerate morphology, and the fluorine-free polymer resin particles in spherical form are dispersed within the ceramic particles, and a coating surface density ρ₀, a coating thickness h₀, an average radius r of fluorine-free polymer resin particles, a volume V₁ occupied by fluorine-free polymer resin particles in the coating, a number N₀ of fluorine-free polymer resin particles, a density ρ of fluorine-free polymer resin, and a coating density ρ₁ of pure ceramic coating satisfy the following relationship. The battery separator provided by the present application has a coating with good bonding property, high consistency, high stability, and good heat resistance.

### TECHNICAL FIELD

The present application relates to the field of batteries and, more particularly, to a battery separator and preparation method therefor, and a battery comprising the battery separator.

### BACKGROUND

With the development of lithium-ion battery technology, there are more and more requirements for the separator. Therefore, the development of the separator is no longer limited to the base film, and the functionality of the coating has been paid more and more attention. For instance, coating modification requires bonding property, heat resistance, electrolyte affinity, and the like of the coating, which provides a technical route for the development of the separator.

The prior art is mostly through the selection of PVDF as the bonding layer, in which PVDF itself, a material with certain bonding property, can be used as a binder for the positive electrode in the battery. According to the current market development, spray coating is mostly carried out to attach PVDF to the surface of ceramic separator to achieve the bonding function.

However, because of the high melting point of PVDF (≥135° C.), the conditions for achieving its bonding property will be more strict, requiring higher temperature and pressure to achieve the adhesion of the separator and the electrode sheets. In addition, since molding particle size of PVDF per se is small, only through agglomeration to form a certain size of agglomerates, a significant bonding effect can be achieved. Because the agglomerates are formed at a later stage, and it is impossible to control the particle size of the agglomerates, the size and morphology of the agglomerates are very different. Therefore, the consistency and stability of the PVDF are very weak, which means that, when PVDF is selected as the bonding layer, the structure is not stable, and is prone to powder falling off, which affects the bonding effect. Moreover, it is difficult to ensure the consistency of the coating, and both the stack density and the morphology of the agglomerates on the coating have obvious differences, making it difficult to control the fraction of coverage, so that the coating cannot be controlled in both micro and macro levels.

### SUMMARY

In view of the above problems, the present application, by using ceramic particles and fluorine-free polymer resin particles for mixing and blending, comprehensively considering and adjusting the coating surface density, ceramic particle size, fluorine-free polymer resin particle size, ceramic thickness and other factors, ultimately provides a coating with good bonding property, high consistency, high stability, and good heat-resistant.

Specifically, the present application provides a battery separator having a coating with good bonding property, high consistency, good stability, and good heat resistance, a preparation method therefor, and a battery including the battery separator.

The present application provides a battery separator comprising a base film and a coating coated on one or both sides of the base film, wherein the coating contains: fluorine-free polymer resin particles and ceramic particles;
wherein the fluorine-free polymer resin particles have a primary particle morphology or a secondary agglomerate morphology, and the fluorine-free polymer resin particles are in spherical form and dispersed within the ceramic particles,
a coating surface density ρ₀, a coating thickness h₀, an average radius r of fluorine-free polymer resin particles, a volume V₁ occupied by fluorine-free polymer resin particles in the coating, a number N₀ of fluorine-free polymer resin particles, a density ρ of fluorine-free polymer resin, and a coating density ρ₁ of pure ceramic coating satisfy the following relationship:

$$\frac{4 π {r}^{3}}{3} \times ρ \times {N}_{0} + ( {h}_{0} - {V}_{1} \times {N}_{0} ) \times {ρ}_{1} = {ρ}_{0}$$

$$0.8 {ρ}_{1} \leq {ρ}_{0} / {h}_{0} \leq 1.2 {ρ}_{1} .$$

The present application also provides a preparation method for the battery separator, for achieving the preparation of the battery separator provided by the present application. However, achieving the battery separator provided by the present application is not limited to the preparation method provided by the present application. The method comprises:
1) dispersing a ceramic powder in water, and sanding and dispersing by a sand mill to form a dispersion;
2) adding a fluorine-free polymer resin liquid in emulsion form to the dispersion, adding a binder, and passing through an 80 mesh to 200 mesh sieve to form a finished slurry; and
3) according to the requirements of a desired coating thickness, coating the finished slurry on one or both sides of a base film using a gravure roller or a wire rod, and after the finished slurry is coated onto surface(s) of the base film, drying with an oven to obtain a battery separator with coating;
wherein, in step 1), a rotational speed of the sanding and dispersing is 500 rpm to 1500 rpm, and a time of the sanding and dispersing is 10 min to 60 min; after the end of step 1), the dispersion is cooled under low-speed stirring to maintain a temperature of the dispersion at ≤70° C., wherein a stirring speed of the low-speed stirring is 20 rpm to 300 rpm;
the finished slurry obtained in step 2) is continuously stirred at a low speed from the completion of configuration until being put into use, so that the finished slurry is always in dynamic equilibrium, and a rotational speed of the low-speed stirring is 10 rpm to 800 rpm; from the beginning of step 2) until the finished slurry is put into use, the slurry is maintained at a temperature of 5° C. to 70° C.; the low-speed stirring is carried out using a stirring tank with stirring blades in both upper and lower parts, and radii of the stirring blades in the upper and lower parts are not the same; and
in step 3), in the battery separator, a coating surface density ρ₀, a coating thickness h₀, an average radius r of fluorine-free polymer resin particles, a volume V₁ occupied by fluorine-free polymer resin particles in the coating, a number N₀ of fluorine-free polymer resin particles, a density ρ of fluorine-free polymer resin, and a coating density ρ₁ of pure ceramic coating satisfy the following relationship:

$$\frac{4 π {r}^{3}}{3} \times ρ \times {N}_{0} + ( {h}_{0} - {V}_{1} \times {N}_{0} ) \times {ρ}_{1} = {ρ}_{0}$$

$$0.8 {ρ}_{1} \leq {ρ}_{0} / {h}_{0} \leq 1.2 {ρ}_{1} .$$

Preferably, in the coating of step 3), high-speed coating is used, and a speed of the high-speed coating is 50 m/min to 250 m/min; and a temperature of the drying is 50° C. to 100° C., preferably 60° C. to 90° C.; and a time of the drying is ≥5 s.

The present application also provides a battery comprising: a positive electrode, a negative electrode, a separator disposed between the positive electrode and the negative electrode, and an electrolyte, wherein the separator is the battery separator provided by the present application.

The technical solution provided by the present application can achieve a coated separator with good bonding property, good consistency, good stability and good heat resistance, and can achieve a balance of the four performances. The coated surface of the separator has good bonding property, and is firmly adhered to the electrode sheet, which is favorable to the assembly of the battery cell and the improvement of the energy density of the battery. The coated surface has a high consistency of ceramic stacking thickness, which in turn improves the consistency of the battery cell performance and increases the cycle life of the battery. Resin particles should be stably fixed on the coating, and if the resin particles detach, it will affect the battery cell assembly and battery cycle life. The good heat shrinkage performance of the separator is conducive to improving the safety of the battery. However, the inventor found that in the prior art, it is often difficult to balance these four performances. For example, the enhancement of the coating bonding property will lead to the reduction of the coating stability performance and heat resistance performance, and will also lead to the deterioration of the coating consistency. Therefore, the present application provides a solution for battery separator, which achieves the compatibility and balance of the four performances by controlling the parameters of the coating in multiple aspects, so as to enhance the quality and efficiency of the back-end battery cell assembly, to improve the energy density and cycle life of the battery, and to benefit the safety of the battery. The present application also provides one of the preparation methods for such a separator.

### BRIEF DESCRIPTION OF THE DRAWINGS

FIG. 1 shows a schematic diagram of a coating structure of a battery separator provided by an example of the present application.

FIG. 2 shows a planar SEM image of the coated film of the battery separator of Example 1 of the present application.

### DETAILED DESCRIPTION

The present application provides a battery separator comprising a base film and a coating coated on one or both sides of the base film, wherein the coating comprises: fluorine-free polymer resin particles and ceramic particles;

wherein the fluorine-free polymer resin particles have a primary particle morphology or a secondary agglomerate morphology, and the fluorine-free polymer resin particles are in spherical form and dispersed within the ceramic particles,
a coating surface density ρ₀, a coating thickness h₀, an average radius r of fluorine-free polymer resin particles, a volume V₁ occupied by fluorine-free polymer resin particles in the coating, a number N₀ of fluorine-free polymer resin particles, a density ρ of fluorine-free polymer resin, and a coating density ρ₁ of pure ceramic coating satisfy the following relationship:

$$\frac{4 π {r}^{3}}{3} \times ρ \times {N}_{0} + ( {h}_{0} - {V}_{1} \times {N}_{0} ) \times {ρ}_{1} = {ρ}_{0}$$

$$0.8 {ρ}_{1} \leq {ρ}_{0} / {h}_{0} \leq 1.2 {ρ}_{1} .$$

In the above relationship equation, V₁ denotes a spherical cap volume (i.e., the volume occupied by the fluorine-free polymer resin particles in the coating), and N₀ denotes the number of fluorine-free polymer resin particles.

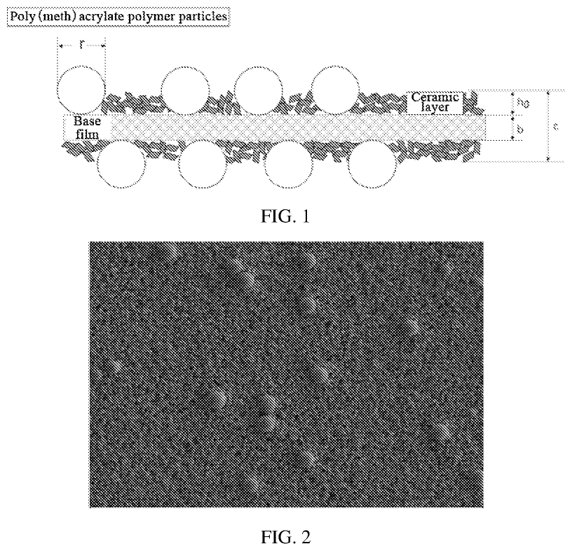

As shown in FIG. 1, the coating is disposed on both sides of the base film, then the coating thickness h₀=(c−b)/2; or, if the coating is disposed on a single side of the base film, then the coating thickness h₀ is the difference between the thickness of the battery separator and the thickness of the base film. In particular, the value of h₀ can be determined by the following method: preparing a cross-sectional sample of the battery separator at 21° C.±4° C. and humidity ≤65% RH, and obtaining a cross-sectional electron micrograph by capturing with an electron microscope of Zeiss SIGMA 300 model. On the picture, the thicknesses at any five positions of the ceramic stacking layer within the single coating were measured, and the average value was taken as the value of h₀.

The spherical cap volume V₁=(π/3)(3r−h)×h², with h being the height of the spherical cap and h=h₀, where it is noted that 2r=D=D50, wherein r is the radius of the sphere of the fluorine-free polymer resin particles, D is the diameter, D−h0>0, and D50 depends on the selection of the raw material of the fluorine-free polymer resin. In particular, the value of D50 can be determined from the raw material, or it can be determined by taking any 5 samples of fluorine-free polymer resin particles using the aforementioned electron microscopy method and converting to the average value.

ρ and ρ₁ are fixed values determined by the fluorine-free polymer resin and the ceramic material. Specifically, ρ is determined by the nature of the raw material, and ρ₁ is determined by the density and particle size of the ceramic. ρ can be measured with the raw material of fluorine-free polymer resin. Alternatively, the fluorine-free polymer resin particles can be separated from the coating and then collected, and ρ can be measured with an electronic scale and a graduated cylinder.

ρ₁ can be obtained by using ceramic particles, coating with a gravure roller or a wire rod to form a film, and measuring the surface density of the film with an electronic scale and a steel straightedge. The ceramic particles used are ceramic particles used as the raw material for the coating, or ceramic particles extracted from the separator coating. The method of extracting the ceramic particles from the separator is not particularly limited. For example, the coating or separator can be dissolved in a solvent to extract the ceramic particles. Specifically: in a first step, the ceramic particles are dispersed into water to make a common ceramic slurry; in a second step, the ceramic slurry is coated into a film using a gravure roller or a wire rod of a corresponding dry thickness; and in a third step, the density of the coating surface is measured by an electronic scale and a steel straightedge to obtain ρ₁.

ρ₀ is the surface density of the coating, which is calculated by the above equation.

Regarding N₀, it is sufficient to count the number of fluorine-free polymer resin particles within the field of view area of the electron microscope at 1000× magnification, and then convert it to the number of fluorine-free polymer resin particles in 1 m² separator based on the field of view area of the electron microscope (for example, using the aforementioned electron microscope method, count the average value of the number of fluorine-free polymer resin particles in 5 electron microscope pictures at 1000× magnification, calculate the area of the field of view of the electron microscope at that magnification, and then convert to the number of fluorine-free polymer resin particles per unit area by the unit, i.e., the number N₀ of particles on an area of 1 m²).

The coating surface density ρ₀ is 0 g/m² to 20 g/m², the coating thickness h₀ is 0.1×10⁶ to 10×10⁻⁶, the average radius r of fluorine-free polymer resin particles is 1×10⁶ m to 4.5×10⁻⁶ m, the volume V₁ occupied by fluorine-free polymer resin particles in the coating is ≥0 m³, the number N₀ of fluorine-free polymer resin particles is ≥1 (being an integer), the density ρ of fluorine-free polymer resin is 0.5×10⁶ g/m³ to 2.0×10⁶ g/m³, and the coating density ρ₁ of pure ceramic coating is 0.5×10⁶ g/m³ to 2.0×10⁶ g/m³.

It should be noted that ρ₀, h₀, r, V₁, N₀, ρ, and ρ₁ should be calculated without considering the unit when substituting them into the relational equation, and that the relational equation and ranges presented in the present application are designed based on the numerical relationships of these parameters, independent of the equivalence of the dimensions.

The fluorine-free polymer resin particles are in spherical form, and the spherical form has excellent structural stability and higher consistency in the coating. The degree of sphericity can be characterized by the method of length-diameter ratio, i.e., the length-diameter ratio S=the longest diameter passing through the interior of the particle/the shortest diameter perpendicular to the longest diameter, and S≤2 indicates that the particles are in spherical form.

The primary particle morphology may be a primary particle morphology in which the inner and outer components are consistent, or a primary particle morphology in which a core-shell structure is present.

The fluorine-free polymer resin has a certain degree of cross-linking and has a low glass transition temperature (Tg), preferably 40° C. to 100° C. Too low Tg will lead to structural instability, and making it prone to structural disintegration or sphere collapse and deformation; and too high Tg will lead to a decrease in sphere bonding property, and making it prone to defects of battery cell softness.

The fluorine-free polymer resin has a certain swelling property, and the swelling rate is preferably 10% to 200%, more preferably 10% to 100%. As a polymer material, a swelling rate that is too small affects the ability of the battery cell to retain liquid; a swelling rate that is too large will likely lead to defects such as high value-added permeability and thickness expansion of the electrode sheet after immersion in the electrolyte, which affects the cycling performance of the battery, and even the loss of bonding property after electrolyte immersion.

The fluorine-free polymer resin preferably has a glass transition temperature of 45° C. to 70° C. and a swelling rate of 10% to 100%.

Preferably, the fluorine-free polymer resin is at least one selected from a poly(meth)acrylate polymer, SBR (styrene butadiene rubber) microspheres, PI (polyimide) water-soluble microspheres, and PAA (polyacrylate) modified microspheres. A primary shaping poly(meth)acrylate polymer is particularly preferred. The acrylate polymer has a very low softening point (about 50° C.), which makes the bonding property conditions substantially lower, and because of its high distribution consistency and uniformity in the coating, the coating adhesive effect is substantially improved (about 2 times to 10 times higher than that of PVDF). Additionally, the component formed by modified grafting of hydrophilic groups on the molecular surface of the acrylate polymer (referred to as: poly(meth)acrylate polymer) can have greatly improved hydrophilicity. Its dispersion difficulty and stability in aqueous solvents are more advantageous than that of PVDF; especially because of the large particle size and low density of the primary particle, it can form a stable mosaic structure in the coating, which can reduce the gram weight of the coating, and at the same time, significantly improve the bonding property and stability.

The average particle size (D50) of the fluorine-free polymer resin particles is preferably 2 μm to 9 μm.

The ceramic particles may be at least one selected from the group consisting of aluminium oxide, boehmite, barium titanate, calcium oxide, magnesium oxide, zinc oxide, zirconium oxide, and silicon oxide, and when the ceramic particles are a mixture of a plurality of components, the amounts of the different components may be in an arbitrary ratio as long as the total amount conforms to the ceramic particles amount limit. Preferably, the ceramic powder is boehmite.

The ceramic particles have an average particle size (D50) of 0.1 μm to 4.0 μm, preferably 0.2 μm to 1.5 μm. The smaller the particle size, the higher the heat-shrinkage performance. The crystals of the ceramic particles should be free of obvious sharp protrusions, so as to avoid the protrusions from damaging the structure of the polymer. The smaller the particle size, the worse the dispersion of the particles in the slurry, to 0.1 μm or less will lead to a larger particle size of the slurry, bringing the risk of poor coating consistency.

The present application also provides a preparation method for battery separator, wherein the method includes the following steps:
step 1) dispersing a ceramic powder in water, and sanding and dispersing by a sand mill to form a dispersion;
step 2) adding a fluorine-free polymer resin liquid in emulsion form to the dispersion, adding a binder, and passing through an 80 mesh to 200 mesh sieve to form a finished slurry; and
step 3) according to the requirements of a desired coating thickness, coating the finished slurry on one or both sides of a base film using a gravure roller or a wire rod, and after the finished slurry is coated onto surface(s) of the base film, drying with an oven to obtain a battery separator with coating;
wherein, in step 1), a rotational speed of the sanding and dispersing is 500 rpm to 1500 rpm, and a time of the sanding and dispersing is 10 min to 60 min; after the end of step 1), the dispersion is cooled under low-speed stirring to maintain a temperature of the dispersion at ≤70° C., wherein a stirring speed of the low-speed stirring is 20 rpm to 300 rpm;
the finished slurry obtained in step 2) is continuously stirred at a low speed from the completion of configuration until being put into use, so that the finished slurry is always in dynamic equilibrium, and a rotational speed of the low-speed stirring is 10 rpm to 800 rpm; from the beginning of step 2) until the finished slurry is put into use, the slurry is maintained at a temperature of 5° C. to 70° C.; the low-speed stirring is carried out using a stirring tank with stirring blades in both upper and lower parts, and radii of the stirring blades in the upper and lower parts are not the same; and
in step 3), in the battery separator, a coating surface density ρ₀, a coating thickness h₀, an average radius r of fluorine-free polymer resin particles, a volume V₁ occupied by fluorine-free polymer resin particles in the coating, a number N₀ of fluorine-free polymer resin particles, a density ρ of fluorine-free polymer resin, and a coating density ρ₁ of pure ceramic coating satisfy the following relationship:

$$\frac{4 π {r}^{3}}{3} \times ρ \times {N}_{0} + ( {h}_{0} - {V}_{1} \times {N}_{0} ) \times {ρ}_{1} = {ρ}_{0}$$

$$0.8 {ρ}_{1} \leq {ρ}_{0} / {h}_{0} \leq 1.2 {ρ}_{1} .$$

The fluorine-free polymer resin liquid in emulsion form used in the above method is not limited to being obtained by commercial purchase or self-made. The self-made method includes: mixing fluorine-free polymer resin powder, a surfactant, and water, dispersing and stirring, and forming the fluorine-free polymer resin liquid in emulsion form. The commercially purchased fluorine-free polymer resin liquid in emulsion form, for example, is: poly(meth)acrylate polymer liquid purchased from Shenzhen Haodian Science and Technology Co., Ltd under the designation of SWA709 used in Examples 1 to 3, which has a glass transition temperature of 55° C., a swelling rate of 70%, and a concentration of poly(meth)acrylate polymer of 25%; poly(meth)acrylate polymer liquid purchased from Zeon Co., Ltd. of Japan, under the designation of BM5000 used in Example 4, which has a glass transition temperature of 54° C., a swelling rate of 97%, and a concentration of poly(meth)acrylate polymer of 19%; and poly(meth)acrylate polymer liquid purchased from Sichuan Jundile Materials Co., Ltd. under the designation of FS400 used in Example 5, which has a glass transition temperature of 68° C., a swelling rate of 68%, and a concentration of poly(meth)acrylate polymer of 30%.

Preferably, the fluorine-free polymer resin liquid in emulsion form described above does not undergo structural decomposition or deformation at pH≥5 and at pH≤10 (the commercially purchased poly(meth)acrylate polymer liquids described above all satisfy this condition). The reason for this is that the aqueous solution of ceramics is mostly alkaline, and the fluorine-free polymer resin liquid with too low a pH will partially undergo structural denaturation after mixing with the ceramics, thus leading to structural instability. Fluorine-free polymer resin powder in the fluorine-free polymer resin liquid in emulsion form has an average particle size D50 of 2 μm to 9 μm, and the ceramic powder has an average particle size D50 of 0.4 μm to 4.0 μm.

In addition, the reason for maintaining the temperature of the dispersion at ≤70° C. after step 1) is that if the temperature is too high, the performance of the coating film will be affected. Processes such as high-speed dispersion or grinding will heat up the dispersion, and the fluorine-free polymer resin material needs to wait until the temperature is lowered to ≤70° C. before adding. The temperature of the dispersion solution exceeding 70° C. will cause the structure of the fluorine-free polymer resin particles to be softened and sticky, and it will be impossible to maintain a complete spherical morphology, which will in turn affect the bonding property and heat resistance of the coating.

The reason for continuously stirring the finished slurry in step 2) at a low speed from the completion of the configuration until being put into use, so that the finished slurry is always in dynamic equilibrium, is to prevent layer separation of the fluorine-free polymer resin particles and the ceramic particles. Such layer separation of the fluorine-free polymer resin particles and the ceramic particles will lead to floating of the fluorine-free polymer resin particles after coating, which not only affects the consistency of the coating, but also affects the stabilization of the structure of the coating, which is prone to the so-called powder falling off such as producing large particles shedding, and imperfect bonding property. Double paddles (i.e., the upper and lower parts of the mixing tank having stirring blades) are used for mixing, and radii of the stirring blades in the upper and lower parts (rᵤₚₚₑᵣ, r_{lower}) should not be the same. That is, the ratio of the radii rᵤₚₚₑᵣ/r_{lower}≠1, of which the purpose is to form a differential speed, so that the organic particles and inorganic particles are evenly dispersed, to eliminate the phenomenon of aggregation, and to improve the stability and consistency of the coating, wherein a rotational speed of the low-speed stirring is 10 rpm to 800 rpm. High-speed stirring will make the slurry to produce foam and thus affect the consistency of the coating. From the beginning of this step until the finished slurry is put into use, the slurry is maintained at a temperature of 5° C. to 70° C., and the reason is that if the temperature is too high, the structure of the fluorine-free polymer resin particles will be softened and sticky, and it will not be possible to maintain a complete spherical morphology, which will affect the bonding property and heat resistance of the coating.

In the coating of step 3), high-speed coating (50 m/min to 250 m/min) is preferable because of the high stability of the finished slurry.

The base film in the present application is not specifically limited, and may be selected with reference to existing lithium-ion battery separators. Typically, the base film may be a polyolefin base film, such as a polypropylene base film, a polyethylene base film, and the like. As one preferred embodiment, the base film is a polyethylene base film.

The base film may have a thickness of 5 μm to 12 μm. The coating may have a thickness of 1 μm to 5 μm, for example 1 μm, 2 μm, 3 μm, 4 μm, or 5 μm.

In the above method, the average particle size D50 of the fluorine-free polymer resin particles is preferably 2 μm to 9 μm; the average particle size D50 of the ceramic powder is preferably 0.4 μm to 1.5 μm.

Based on the total weight of the finished slurry, the fluorine-free polymer resin powder is 0.5 wt. % to 10 wt. %, and the ceramic powder is 15 wt. % to 40 wt. %, more preferably 20 wt. % to 35 wt. %.

A temperature of the drying is 50° C. to 100° C., and a time of the drying is ≥5 s.

The present application has no particular limitations on the surfactant, water and binder and the amounts thereof, and products commonly used in the field, such as those disclosed in CN115117559 A and the proportions thereof, may be used. For example the surfactant comprises surfactant A and surfactant B, the surfactant A being a polyether siloxane copolymer, and the surfactant B being a polysiloxane. The binder is at least one selected from the group consisting of polyacrylic acid, polyvinyl alcohol, polyvinyl ethyl ether, polymethylmethacrylate, polyvinyl acetate and polyurethane, preferably polyacrylic acid. Based on the total weight of the finished slurry, the surfactant A is 0.06 wt. % to 0.5 wt. %, the surfactant B is 0.1 wt. % to 0.5 wt. %, the water is 40 wt. % to 60 wt. %, and the binder is 5 wt. % to 10 wt. %.

The present application also provides a battery comprising: a positive electrode, a negative electrode, a separator disposed between the positive electrode and the negative electrode, and an electrolyte, wherein the separator is the battery separator provided by the present application.

The battery separator provided by the present application has a coating with good bonding property, high consistency, high stability, and good heat resistance. The coating has a bonding strength ≥0.6 N/m, a consistency R≤0.5 μm, a probability of particle dropout ≤3%, and a thermal shrinkage rate ≤5%.

The application is further described below in connection with examples, but the scope of the application is not limited to these examples.

### EXAMPLE

In the following examples and comparative examples, the binder is a polyacrylic acid emulsion, purchased from Hunan Gaorui Power Material Co., Ltd. under the designation of LIB-S105B.

In the following examples and comparative examples, the number of parts refers to parts by weight unless otherwise indicated.

The following Examples 1 to 5 are used to illustrate the battery separator of the present application and the preparation method of therefor.

### Example 1

1) 30 parts of boehmite (D50 of 0.8 μm) were dispersed in 54 parts of water, and sanded and dispersed by a sand mill (speed of 1000 rpm, time of 30 min) to form a dispersion. The dispersion was cooled down under low-speed (150 rpm) stirring to maintain the temperature of the dispersion at ≤70° C.
2) To the dispersion was added 6 parts of poly(meth)acrylate polymer liquid in emulsion form (pH being 6.5, the glass transition temperature being 55° C., the swelling rate being 70%, D50 of the poly(meth)acrylate polymer being 4.5 μm, the concentration of the poly(meth)acrylate polymer being 25%), and 10 parts of binder, which was passed through a 200 mesh sieve to form a finished slurry.

The above finished slurry was stirred at a low speed (300 rpm) using double paddles (i.e., both the upper and lower parts of the mixing tank had mixing blades) from the time it was made until it was used in the next step, in which the radii of the upper and lower mixing blades (Tupper, flower) satisfy the relationship “the ratio of the radii rᵤₚₚₑᵣ/r_{lower}≠1”, and the slurry was kept between 5° C. and 70° C. from the beginning of step 2) until the finished slurry was used in the next step.
3) According to the requirements of the desired coating thickness, the finished slurry was coated on both sides of the 7 μm thick base film using a gravure roller or a wire rod, and after the finished slurry was coated onto the surface of the base film, the finished slurry was dried with an oven (the temperature of the drying being 75° C., and the time of the drying being 10 s) to obtain a battery separator B1 with coating film.

Among the above, in step 3), in the battery separator, a coating surface density ρ₀, a coating thickness h₀, an average radius r of fluorine-free polymer resin particles, a volume V₁ occupied by fluorine-free polymer resin particles in the coating, a number N₀ of fluorine-free polymer resin particles, a density ρ of fluorine-free polymer resin, and a coating density ρ₁ of pure ceramic coating satisfy the following relationship:

$$\frac{4 π {r}^{3}}{3} \times ρ \times {N}_{0} + ( {h}_{0} - {V}_{1} \times {N}_{0} ) \times {ρ}_{1} = {ρ}_{0}$$

$$0.8 {ρ}_{1} \leq {ρ}_{0} / {h}_{0} \leq 1.2 {ρ}_{1} .$$

Each of the above parameters was measured as described in the present application and will not be repeated herein. The measured data are shown in Table 1 below.

Example 2: In this example, the method was the same as in Example 1 except that the parameters were changed as shown in Table 1, and a battery separator B2 with a coating film was produced. The produced battery separator satisfied the equation of the present application.

Example 3: In this example, the method was the same as in Example 1 except that the parameters were changed as shown in Table 1, and a battery separator B3 with a coating film was produced. The produced battery separator satisfied the equation of the present application.

Example 4: In this example, in addition to changing the parameters as shown in Table 1, the parameters of the poly(meth)acrylate polymer liquid used in step 2) were as follows: pH being 7.9, glass transition temperature being 54° C., swelling rate being 97%, D50 of the poly(meth)acrylate polymer being 4.5 μm, and concentration of poly(meth)acrylate polymer being 25%, the method was the same as in Example 1, and a battery separator B4 with a coating film was produced.

Example 5: In this example, in addition to changing the parameters as shown in Table 1, the parameters of the poly(meth)acrylate polymer liquid used in step 2) were as follows: pH being 9.4, glass transition temperature being 68° C., swelling rate being 68%, D50 of the poly(meth)acrylate polymer being 9 μm, and concentration of the poly(meth)acrylate polymer being 25%, the method was the same as in Example 1, and a battery separator B5 with a coating film was produced.

Example 6: Except that the boehmite was changed to a mixture of boehmite and BaTiO₃ (mass ratio 3:1) in step 1), the performance parameters of the poly(meth)acrylate polymer liquid in step 2 were as follows: pH being 6.5, glass transition temperature being 45° C., swelling rate being 150%, D50 of the poly(meth)acrylate polymer being 2.2 μm, and concentration of the poly(meth)acrylate polymer being 25%, and the amount of each component was changed according to Table 1, the rest was the same as in Example 1, and a battery separator B6 with a coating film was produced.

Example 7: Except that the boehmite was changed to a mixture of boehmite and BaTiO₃ (mass ratio 9:1) in step 1), the performance parameters of the poly(meth)acrylate polymer liquid in step 2 were as follows: pH being 6.5, glass transition temperature being 76° C., swelling rate being 88%, D50 of the poly(meth)acrylate polymer being 3 μm, and concentration of the poly(meth)acrylate polymer being 25%, the amount of each component was changed according to Table 1, the rest was the same as in Example 1, and a battery separator B7 with a coating film was produced.

Example 8: Except that the boehmite was changed to a mixture of boehmite and BaTiO₃ (mass ratio 9:5) in step 1), the poly(meth)acrylate polymer liquid was changed to a solution of SBR (styrene butadiene rubber) microspheres in step 2, with the following performance parameters: pH being 7.2, glass transition temperature being 88° C., swelling rate being 30%, D50 of SBR (styrene butadiene rubber) microspheres being 2.5 μm, and concentration of SBR (styrene butadiene rubber) microspheres being 25%, the amount of each component was changed according to Table 1, the rest was the same as that in Example 1, and a battery separator B8 with a coating film was produced.

Example 9: In addition to changing the boehmite to a mixture of boehmite and BaTiO₃ (mass ratio 3:1) in step 1), the poly(meth)acrylate polymer liquid was changed to a solution of PI (polyimide) water-soluble microspheres in step 2, with the following performance parameters: pH being 6.8, glass transition temperature being 90° C., swelling rate being 55%, D50 of PI (polyimide) water-soluble microspheres being 4.5 μm, and concentration of PI (polyimide) water-soluble microspheres being 25%, the amount of each component was changed according to Table 1, the rest was the same as that in Example 1, and a battery separator B9 with a coating film was produced.

Comparative example 1: In this comparative example, the method was the same as in Example 1 except that a PVDF liquid self-made from PVDF powder was used instead of the poly(meth)acrylate polymer liquid, and a battery separator C1 with a coating film was produced.

PVDF liquid was prepared as follows: 1.5 parts of PVDF powder, 0.005 parts of polysiloxane surfactant, and 4.5 parts of water were mixed to obtain 6 parts of PVDF liquid.

The PVDF powder was purchased from Dongyangguang Company, under the designation of 2600.

In this comparative example, the density of the PVDF cannot be calculated due to the unstable morphology of the PVDF spheres, and therefore this comparative example is not applicable to the equation of the present application.

Comparative examples 2 to 3: Except that some of the parameter data as shown in Table 1 were different from that of Example 1, that the dispersion formed in step 1) of the slurrying process was directly mixed in the next step without cooling down, and that the finished slurry was stirred at a low speed (300 rpm) using a single paddle from the time it was made until it was used in the next step, i.e., the stirring paddle had relationship of “the ratio of the radii rᵤₚₚₑᵣ/r_{lower}=1”, the rest was the same as that in Example 1, and the battery separators C2 to C3 with a coating film were produced.

Comparative example 4: The same as Example 8 except that the type of fluorine-free polymer resin was different from Example 8, and the performance parameters of the poly(meth)acrylate polymer liquid used in this comparative example were as follows: pH being 6.5, glass transition temperature being 38° C., swelling rate being 244%, D50 of the poly(meth)acrylate polymer being 1 μm, and concentration of the poly(meth)acrylate polymer being 25%.

Comparative example 5: The same as Example 8 except that the type of fluorine-free polymer resin was different from Example 8, and the performance parameters of the poly(meth)acrylate polymer liquid used in this comparative example were as follows: pH being 6.5, glass transition temperature being 37° C., swelling rate being 300%, D50 of the poly(meth)acrylate polymer being 4.5 μm, and concentration of the poly(meth)acrylate polymer being 25%.

Comparative example 6: In this comparative example, the method is the same as in Example 1 except that the parameters are changed according to Table 1, and a battery separator C6 with a coating film was produced. The produced battery separator does not satisfy the equation of the present application.

TABLE 1
Parameter data for B1 to B9 and C2 to C6

| Parameters | Example 1 | Example 2 | Example 3 | Example 4 | Example 5 | Example 6 | Example 7 |
|---|---|---|---|---|---|---|---|
| Ceramic type | Boehmite | Boehmite | Boehmite | Boehmite | Boehmite | Bochmite, | Boehmite, |
| | | | | | | BaTiO3 | BaTiO3 |
| Average particle size of | 0.8 | 0.2 | 1.5 | 0.8 | 1.2 | 0.5 | 0.6 |
| ceramic particles D50 | | | | | | | |
| (μm) | | | | | | | |
| Amount of ceramic | 30 | 20 | 35 | 30 | 30 | 24 | 27 |
| particles (parts) | | | | | | | |
| Amount of water (parts) | 54 | 50 | 41 | 54 | 54 | 41 | 45 |
| Rotational speed of | 1000 | 1300 | 500 | 1000 | 1000 | 1000 | 1000 |
| sanding and | | | | | | | |
| dispersing (rpm) | | | | | | | |
| Time of the sanding | 30 | 60 | 20 | 30 | 30 | 30 | 30 |
| and dispersion (min) | | | | | | | |
| Stirring speed of cooling | 150 | 20 | 300 | 150 | 150 | 150 | 150 |
| the dispersion at | | | | | | | |
| low speed (rpm) | | | | | | | |
| Temperature of the | ≤70 | Same as | Same as | Same as | Same as | Same as | Same as |
| dispersion (° C.) | | Example 1 | Example 1 | Example 1 | Example 1 | Example 1 | Example 1 |
| Weight ratio of ceramic | 30 | 20 | 35 | 30 | 30 | 24 | 27 |
| particles (%) based on | | | | | | | |
| the total weight of | | | | | | | |
| the finished slurry | | | | | | | |
| Amount of binder added | 10 | 23.4 | 15.3 | 10 | 10 | 11 | 12.1 |
| (parts) | | | | | | | |
| Fluorine-free polymer | Poly | Poly | Poly | Poly | Poly | Poly | Poly |
| resin type | (meth) | (meth) | (meth) | (meth) | (meth) | (meth) | (meth) |
| | acrylate | acrylate | acrylate | acrylate | acrylate | acrylate | acrylate |
| Average particle size of | 4.5 | 2.5 | 6 | 4.5 | 9 | 2.2 | 3 |
| fluorine-free polymer | | | | | | | |
| resin particles D50 (μm) | | | | | | | |
| Amount of fluorine-free | 6 | 6.6 | 8.7 | 6 | 6 | 24 | 15.9 |
| polymer resin liquid | | | | | | | |
| (parts) | | | | | | | |
| Glass transition | 55 | 55 | 55 | 54 | 68 | 45 | 76 |
| temperature of | | | | | | | |
| fluorine-free polymer | | | | | | | |
| resin (° C.) | | | | | | | |
| Swelling rate of | 70 | 70 | 70 | 97 | 68 | 150 | 88 |
| fluorine-free polymer | | | | | | | |
| resin (%) | | | | | | | |
| Weight ratio of | 1.5 | 1.7 | 2.2 | 1.5 | 1.3 | 6.0 | 4.0 |
| fluorine-free polymer | | | | | | | |
| resin (%) based on the | | | | | | | |
| total weight of the | | | | | | | |
| finished slurry | | | | | | | |
| Whether there are | No | Same as | Same as | Same as | Same as | Same as | Same as |
| fluorine-free polymer | | Example 1 | Example 1 | Example 1 | Example 1 | Example 1 | Example 1 |
| resin particles floating | | | | | | | |
| in the slurry | | | | | | | |
| Ratio of stirring blade | 10 | Same as | Same as | Same as | Same as | 50 | 50 |
| radii rᵤₚₚₑᵣ/r_{lower} | | Example 1 | Example 1 | Example 1 | Example 1 | | |
| (%) | | | | | | | |
| Mixing speed (rpm) of | 300 | 10 | 800 | 300 | 300 | 300 | 300 |
| mixing the finished | | | | | | | |
| slurry at low speed | | | | | | | |
| Slurry temperature | 5° C.- | Same as | Same as | Same as | Same as | Same as | Same as |
| (° C.) | 70° C. | Example 1 | Example 1 | Example 1 | Example 1 | Example 1 | Example 1 |
| Coating speed (m/min) | 150 | Same as | Same as | Same as | Same as | 200 | 200 |
| | | Example 1 | Example 1 | Example 1 | Example 1 | | |
| Drying temperature | 75 | 60 | 90 | Same as | Same as | Same as | Same as |
| (° C.) | | | | Example 1 | Example 1 | Example 1 | Example 1 |
| Drying time (s) | 10 | 20 | 5 | Same as | Same as | Same as | Same as |
| | | | | Example 1 | Example 1 | Example 1 | Example 1 |
| Coating thickness h₀ (m) | 2 × | 1.0 × | 2 × | 3.5 × | 4 × | 1.8 × | 1.5 × |
| | 10⁻⁶ | 10⁻⁶ | 10⁻⁶ | 10⁻⁶ | 10⁻⁶ | 10⁻⁶ | 10⁻⁶ |
| Spherical cap volume | 1.99 × | 2.88 × | 7.06 × | 1.99 × | 1.59 × | 4.24 × | 7.1 × |
| V₁ (m³) | 10⁻¹⁷ | 10⁻¹⁸ | 10⁻¹⁷ | 10⁻¹⁷ | 10⁻¹⁶ | 10⁻¹⁸ | 10⁻¹⁸ |
| Number of fluorine-free | 2.3 × | 4.0 × | 1.7 × | 2.3 × | 1.2 × | 1.4 × | 8.14 × |
| polymer resin particles | 10⁹ | 10¹⁰ | 10⁹ | 10⁹ | 10⁹ | 10¹¹ | 10¹⁰ |
| N₀ (counts) | | | | | | | |
| Density of fluorine-free | 1.1 × | 1.1 × | 1.1 × | 1.1 × | 1.08 × | 1.1 × | 1.1 × |
| polymer resin ρ (g/m³) | 10⁶ | 10⁶ | 10⁶ | 10⁶ | 10⁶ | 10⁶ | 10⁶ |
| Coating density of pure | 1.4 × | 1.7 × | 1.0 × | 1.4 × | 1.0 × | 2.1 × | 1.5 × |
| ceramic coating ρ₁ | 10⁶ | 10⁶ | 10⁶ | 10⁶ | 10⁶ | 10⁶ | 10⁶ |
| (g/m³) | | | | | | | |
| Coating surface density | 2.85 | 1.86 | 3.59 | 2.85 | 4.3 | 3.14 | 2.65 |
| ρ₀ (g/m²) | | | | | | | |
| Relationship of | 1.0 | 1.1 | 1.0 | 1 | 1.1 | 0.8 | 1.2 |
| (ρ₀/h₀)/ρ₁ | | | | | | | |
| | | | Com- | Com- | Com- | Com- | Com- |
| | | | para- | para- | para- | para- | para- |
| | Exam- | Exam- | tive | tive | tive | tive | tive |
| Parameters | ple 8 | ple 9 | example 2 | example 3 | example 4 | example 5 | example 6 |
| Ceramic type | Boehmite, | Bochmite, | Boehmite | Boehmite | Boehmite, | Bochmite, | Boehmite |
| | BaTiO3 | BaTiO3 | | | BaTiO3 | BaTiO3 | |
| Average particle size of | 0.8 | 0.6 | 1.5 | 0.15 | 0.8 | 0.8 | 0.8 |
| ceramic particles D50 | | | | | | | |
| (μm) | | | | | | | |
| Amount of ceramic | 27 | 30 | 30 | 30 | 27 | 27 | 28 |
| particles (parts) | | | | | | | |
| Amount of water (parts) | 45 | 54 | 54 | 54 | 45 | 45 | 49 |
| Rotational speed of | 1000 | 1000 | 1000 | 1000 | 1000 | 1000 | 1000 |
| sanding and | | | | | | | |
| dispersing (rpm) | | | | | | | |
| Time of the sanding | 30 | 30 | 30 | 30 | 30 | 30 | 30 |
| and dispersion (min) | | | | | | | |
| Stirring speed of cooling | 150 | 150 | 150 | 150 | 150 | 150 | 150 |
| the dispersion at | | | | | | | |
| low speed (rpm) | | | | | | | |
| Temperature of the | Same as | Same as | >70 | >70 | Same as | Same as | Same as |
| dispersion (° C.) | Example 1 | Example 1 | | | Example 1 | Example 1 | Example 1 |
| Weight ratio of ceramic | 27 | 30 | 30 | 30 | 27 | 27 | 28 |
| particles (%) based on | | | | | | | |
| the total weight of | | | | | | | |
| the finished slurry | | | | | | | |
| Amount of binder added | 12.1 | 10 | 10 | 10 | 12.1 | 12.1 | 10.9 |
| (parts) | | | | | | | |
| Fluorine-free polymer | SBR | PI | Poly | Poly | Poly | Poly | Poly |
| resin type | (styrene | (poly- | (meth) | (meth) | (meth) | (meth) | (meth) |
| | butadiene | imide) | acrylate | acrylate | acrylate | acrylate | acrylate |
| | rubber) | water- | | | | | |
| | micro- | soluble | | | | | |
| | spheres | micro- | | | | | |
| | | spheres | | | | | |
| Average particle size of | 2.5 | 4.5 | 10 | 1 | 1 | 4.5 | 3 |
| fluorine-free polymer | | | | | | | |
| resin particles D50 (μm) | | | | | | | |
| Amount of fluorine-free | 15.9 | 6 | 6 | 6 | 15.9 | 15.9 | 12.1 |
| polymer resin liquid | | | | | | | |
| (parts) | | | | | | | |
| Glass transition | 88 | 90 | 55 | 55 | 38 | 37 | 55 |
| temperature of | | | | | | | |
| fluorine-free polymer | | | | | | | |
| resin (° C.) | | | | | | | |
| Swelling rate of | 30 | 55 | 70 | 70 | 244 | 300 | 70 |
| fluorine-free polymer | | | | | | | |
| resin (%) | | | | | | | |
| Weight ratio of | 4.0 | 1.5 | 1.5 | 1.5 | 4.0 | 4.0 | 3.0 |
| fluorine-free polymer | | | | | | | |
| resin (%) based on the | | | | | | | |
| total weight of the | | | | | | | |
| finished slurry | | | | | | | |
| Whether there are | Same as | Same as | Same as | Same as | Same as | Yes | Same as |
| fluorine-free polymer | Example 1 | Example 1 | Example 1 | Example 1 | Example 1 | | Example 1 |
| resin particles floating | | | | | | | |
| in the slurry | | | | | | | |
| Ratio of stirring blade | 75 | 75 | 1 | 1 | Same as | Same as | Same as |
| radii rᵤₚₚₑᵣ/r_{lower} | | | | | Example 1 | Example 1 | Example 1 |
| (%) | | | | | | | |
| Mixing speed (rpm) of | 300 | 300 | 300 | 300 | 300 | 300 | 300 |
| mixing the finished | | | | | | | |
| slurry at low speed | | | | | | | |
| Slurry temperature | Same as | Same as | Same as | Same as | Same as | >70 | Same as |
| (° C.) | Example 1 | Example 1 | Example 1 | Example 1 | Example 1 | | Example 1 |
| Coating speed (m/min) | 250 | 250 | Same as | Same as | Same as | Same as | Same as |
| | | | Example 1 | Example 1 | Example 1 | Example 1 | Example 1 |
| Drying temperature | Same as | Same as | 75 | 75 | Same as | Same as | Same as |
| (° C.) | Example 1 | Example 1 | | | Example 1 | Example 1 | Example 1 |
| Drying time (s) | Same as | Same as | 10 | 10 | Same as | Same as | Same as |
| | Example 1 | Example 1 | | | Example 1 | Example 1 | Example 1 |
| Coating thickness h₀ (m) | 2 × | 2 × | 2 × | 8 × | 1 × | 1 × | 1 × |
| | 10⁻⁶ | 10⁻⁶ | 10⁻⁶ | 10⁻⁷ | 10⁻⁶ | 10⁻⁶ | 10⁻⁶ |
| Spherical cap volume | 5.8 × | 1.99 × | 5.44 × | 4.69 × | 5.24 × | 6.02 × | 3.67 × |
| V₁ (m³) | 10⁻¹⁸ | 10⁻¹⁷ | 10⁻¹⁷ | 10⁻¹⁹ | 10⁻¹⁹ | 10⁻¹⁸ | 10⁻¹⁸ |
| Number of fluorine-free | 9.3 × | 2.3 × | 1.3 × | 1.1 × | 1.74 × | 8.14 × | 3.49 × |
| polymer resin particles | 10¹⁰ | 10⁹ | 10⁹ | 10¹² | 10¹² | 10⁹ | 10¹⁰ |
| N₀ (counts) | | | | | | | |
| Density of fluorine-free | 0.94 × | 1.15 × | 1.1 × | 1.1 × | 1.1 × | 1.1 × | 1.15 × |
| polymer resin ρ (g/m³) | 10⁶ | 10⁶ | 10⁶ | 10⁶ | 10⁶ | 10⁶ | 10⁶ |
| Coating density of pure | 1.6 × | 1.5 × | 1.0 × | 2.3 × | 1.6 × | 1.4 × | 1.4 × |
| ceramic coating ρ₁ | 10⁶ | 10⁶ | 10⁶ | 10⁶ | 10⁶ | 10⁶ | 10⁶ |
| (g/m³) | | | | | | | |
| Coating surface density | 2.82 | 3.06 | 2.64 | 1.29 | 1.14 | 1.76 | 1.79 |
| ρ₀ (g/m²) | | | | | | | |
| Relationship of | 0.9 | 1 | 1.3 | 0.7 | 0.7 | 1.3 | 1.3 |
| (ρ₀/h₀)/ρ₁ | | | | | | | |

The performance of battery separators B1 to B9 and C2 to C6 were tested as follows, and the results are shown in Table 2 below.

### (1) Bonding Property:

The bonding property referred to in the present application is the degree to which the battery separator is tightly and uniformly bonded to the battery electrode sheet during battery cell assembly. In particular, the bonding property is assessed in accordance with the following method: testing with reference to the requirements of GB/T 2792.
1) Stacking A4 paper and the separator in the order of A4 paper/separator/separator/A4 paper, with the separator coating facing towards the separator coating;
2) performing thermoplastic treatment to the stacked A4 paper and separator at 100° C.; and
3) cutting the separator after thermoplastic treatment into a long strip of 200 mm long and 25 mm wide, with the distance between the clamps being (100±5) mm, and the test speed being (50±10) mm/min.

### (2) Consistency:

The consistency referred to in the present application is the degree of uniformity and consistency of the stacking of the ceramic particles within the mixed coating of the fluorine-free polymer resin particles and the ceramic particles. The presence of larger particles of the fluorine-free polymer resin will cause the uniformity of the stacking of the ceramic particles to deteriorate, adversely affecting the uniformity of the mechanical structure of the coating.

Using a foam having a certain resilience and density (the present application used a beauty blender made of polyurethane type foam), the thickness of the ceramic layer can be obtained and monitored by placing the prepared battery separator on a horizontal table, fixing the separator with one hand, and using the foam with the other hand to wipe the surface of the film 6 times to 8 times from left to right, so that the PMMA particles can be removed from the coating without damaging the ceramic layer. In particular, the consistency can be evaluated by preparing a cross-section sample of the battery separator at 21° C.±4° C. and humidity≤65% RH, and obtaining a cross-section electron microscope picture by capturing with an electron microscope of Zeiss brand SIGMA 300 model. On the picture, the thicknesses at any 10 positions of the single-coated ceramic stacking layer were measured, the extreme difference R (max-min) of the thicknesses at these 10 positions was calculated, and good consistency was indicated if R≤0.5 μm.

### (3) Stability:

The stability referred to in the present application is the degree of firmness to which the fluorine-free polymer resin particles are embedded in the coating.

In particular, the stability can be evaluated by: randomly sampling the finished battery separator after it has been rolled over a 90-degree angle wrapped roller for 20 times, taking 1000× electron microscope images (which can be 500× to 5000×), and counting the probability of particles falling off (number of PMMA or PVDF particles falling off/total number of PMMA or PVDF particles).

### (4) Heat Resistance:

The heat resistance referred to in the present application is the heat shrinkage performance of the battery separator. In particular, the heat resistance can be assessed by measuring the heat shrinkage rate, which is tested in accordance with the method specified in GB/T12027-2004, and the average of the heat shrinkage rate in the TD direction and the heat shrinkage rate in the MD direction is taken.

TABLE 2
Performance test results for B1 to B5 and C1 to C3

| Performance | | | | | | | | | |
|---|---|---|---|---|---|---|---|---|---|
| of battery | Exam- | Exam- | Exam- | Exam- | Exam- | Exam- | Exam- | Exam- | Exam- |
| Separator | ple 1 | ple 2 | ple 3 | ple 4 | ple 5 | ple 6 | ple 7 | ple 8 | ple 9 |
| Bonding | 1.2 | 7.4 | 1.5 | 1.9 | 0.8 | 8.2 | 2.5 | 3.3 | 1.9 |
| property: | | | | | | | | | |
| bonding strength | | | | | | | | | |
| (N/m) | | | | | | | | | |
| Consistency | 0.2 | 0.1 | 0.4 | 0.2 | 0.3 | 0.2 | 0.4 | 0.1 | 0.4 |
| (μm) | | | | | | | | | |
| Stability: | 0 | 0 | 0 | 0 | 0 | 0 | 1 | 0 | 0 |
| probability of | | | | | | | | | |
| particle falling | | | | | | | | | |
| off | | | | | | | | | |
| Heat resistance: | 1.5 | 1.7 | 1.9 | 1.5 | 1.4 | 4.5 | 2.9 | 2 | 0.5 |
| Heat shrinkage | | | | | | | | | |
| (%) | | | | | | | | | |

| | Compara- | Compara- | Compara- | Compara- | Compara- | Compara- |
|---|---|---|---|---|---|---|
| Performance | tive | tive | tive | tive | tive | tive |
| of battery | example | example | example | example | example | example |
| Separator | 1 | 2 | 3 | 4 | 5 | 6 |
| Bonding | 0.4 | 2.1 | 6.0 | 0.5 | 2.2 | 6.6 |
| property: | | | | | | |
| bonding strength | | | | | | |
| (N/m) | | | | | | |
| Consistency | 0.9 | 0.7 | 0.2 | 0.1 | 0.2 | 0.4 |
| (μm) | | | | | | |
| Stability: | 9 | 50 | 1 | 0 | 13 | 10 |
| probability of | | | | | | |
| particle falling | | | | | | |
| off | | | | | | |
| Heat resistance: | 9.7 | 0.9 | 28 | 39 | 58 | 44 |
| Heat shrinkage | | | | | | |
| (%) | | | | | | |

As can be seen from the data in Table 2, the battery separator provided by the present application has a coating with good bonding property, high consistency, high stability, and good heat resistance.

As for the battery separator prepared in Comparative example 1, due to the use of PVDF, that is prone to float on the surface of the coating, the coating was very unstable, and the coating has a high thermal shrinkage and poor heat resistance.

As can be seen from Tables 1 and 2, regardless of how the various types of parameters change, when the condition of “0.8ρ₁≤p₀/h₀≤1.2ρ₁” is satisfied, the coating combines the advantages of good bonding property, high consistency, high stability, and good heat resistance. Whereas, when the above condition is not satisfied, the balanced advantages no longer exist. Other parameters in the examples that are not limited by ρ, ρ₀, and h₀ can be adjusted within the range provided by the present application for achieving the condition “0.8ρ₁≤ρ₀/h₀≤1.2ρ₁”, which is not necessary for the achievement of the condition.

The battery separator provided by the present application is not limited to being prepared by the preparation method provided by the present application, and any battery separator obtained by other methods in accordance with the present application shall fall within the scope of protection of the claims of the present application.

At the same time, the present application may also have a variety of other embodiments, and without departing from the spirit and essence of the present application, a person skilled in the art may make various corresponding changes and modifications in accordance with the present application, but these corresponding changes and modifications shall all fall within the scope of protection of the claims of the present application.

1. A battery separator comprising a base film and a coating coated on one or both sides of the base film, wherein
the coating comprises: fluorine-free polymer resin particles and ceramic particles;
wherein the fluorine-free polymer resin particles have a primary particle morphology or a secondary agglomerate morphology, and the fluorine-free polymer resin particles are in spherical form and dispersed within the ceramic particles,
a coating surface density ρ₀, a coating thickness h₀, an average radius r of fluorine-free polymer resin particles, a volume V₁ occupied by fluorine-free polymer resin particles in the coating, a number N₀ of fluorine-free polymer resin particles, a density ρ of fluorine-free polymer resin, and a coating density ρ₁ of pure ceramic coating satisfy the following relationship:
$$\frac{4 π {r}^{3}}{3} \times ρ \times {N}_{0} + ( {h}_{0} - {V}_{1} \times {N}_{0} ) \times {ρ}_{1} = {ρ}_{0}$$
$$0.8 {ρ}_{1} \leq {ρ}_{0} / {h}_{0} \leq 1.2 {ρ}_{1} ;$$
the fluorine-free polymer resin has a glass transition temperature of 40° C. to 100° C. and a swelling rate of 10% to 200%; and
N₀ is the number of fluorine-free polymer resin particles comprised in a 1 m² separator, which is obtained by first counting a number of fluorine-free polymer resin particles under 1K electron microscopy and then converting counted number according to area.

2. The battery separator according to claim 1, wherein the fluorine-free polymer resin has the glass transition temperature of 45° C. to 70° C. and the swelling rate of 10% to 100%.

3. The battery separator according to claim 1, wherein the fluorine-free polymer resin is a poly(meth)acrylate polymer.

4. The battery separator according to claim 1, wherein the fluorine-free polymer resin particles have an average particle size D50 of 2 μm to 9 μm.

5. The battery separator according to claim 1, wherein the ceramic particles are at least one selected from the group consisting of aluminium oxide, boehmite, barium titanate, calcium oxide, magnesium oxide, zinc oxide, zirconium oxide, and silicon oxide.

6. The battery separator according to claim 5, wherein the ceramic particles are boehmite.

7. The battery separator according to claim 1, wherein the ceramic particles have an average particle size D50 of 0.1 μm to 4.0 μm.

8. A preparation method for battery separator, wherein the method comprises the following steps:
step 1) dispersing a ceramic powder in water, and sanding and dispersing by a sand mill to form a dispersion;
step 2) adding a fluorine-free polymer resin liquid in emulsion form to the dispersion, adding a binder, and passing through an 80 mesh to 200 mesh sieve to form a finished slurry; and
step 3) according to the requirements of a desired coating thickness, coating the finished slurry on one or both sides of a base film using a gravure roller or a wire rod, and after the finished slurry is coated onto surface(s) of the base film, drying with an oven to obtain a battery separator with coating;
wherein, in step 1), a rotational speed of the sanding and dispersing is 500 rpm to 1500 rpm, and a time of the sanding and dispersing is 10 min to 60 min; after the end of step 1), the dispersion is cooled under low-speed stirring to maintain a temperature of the dispersion at ≤70° C., wherein a stirring speed of the low-speed stirring is 20 rpm to 300 rpm;
the finished slurry obtained in step 2) is continuously stirred at a low speed from the completion of configuration until being put into use, so that the finished slurry is always in dynamic equilibrium, and a rotational speed of the low-speed stirring is 10 rpm to 800 rpm; from the beginning of step 2) until the finished slurry is put into use, the slurry is maintained at a temperature of 5° C. to 70° C.; the low-speed stirring is carried out using a stirring tank with stirring blades in both upper and lower parts, and radii of the stirring blades in the upper and lower parts are not the same;
in step 3), in the battery separator, a coating surface density ρ₀, a coating thickness h₀, an average radius r of fluorine-free polymer resin particles, a volume V₁ occupied by fluorine-free polymer resin particles in the coating, a number N₀ of fluorine-free polymer resin particles, a density ρ of fluorine-free polymer resin, and a coating density ρ₁ of pure ceramic coating satisfy the following relationship:
$$\frac{4 π {r}^{3}}{3} \times ρ \times {N}_{0} + ( {h}_{0} - {V}_{1} \times {N}_{0} ) \times {ρ}_{1} = {ρ}_{0}$$
$$0.8 {ρ}_{1} \leq {ρ}_{0} / {h}_{0} \leq 1.2 {ρ}_{1} ;$$
the fluorine-free polymer resin has a glass transition temperature of 40° C. to 100° C. and a swelling rate of 10% to 200%; and
N₀ is the number of fluorine-free polymer resin particles comprised in a 1 m² separator, which is obtained by first counting a number of fluorine-free polymer resin particles under 1K electron microscopy and then converting counted number according to area.

9. The preparation method according to claim 8, wherein the fluorine-free polymer resin liquid in emulsion form does not undergo structural decomposition or deformation at pH≥5 and at pH≤10; fluorine-free polymer resin powder in the fluorine-free polymer resin liquid in emulsion form has an average particle size D50 of 2 μm to 9 μm; and
the ceramic powder has an average particle size D50 of 0.4 μm to 4.0 μm.

10. The preparation method according to claim 8, wherein, based on the total weight of the finished slurry, the fluorine-free polymer resin powder is 0.5 wt. % to 10 wt. %, and the ceramic powder is 15 wt. % to 40 wt. %.

11. The preparation method according to claim 10, wherein, based on the total weight of the finished slurry, the fluorine-free polymer resin powder is 5 wt. % to 10 wt. %; and the ceramic powder is 20 wt. % to 35 wt. %.

12. The preparation method according to claim 8, wherein, in the coating of step 3), high-speed coating is used, and a speed of the high-speed coating is 50 m/min to 250 m/min; and
a temperature of the drying is 50° C. to 100° C., and a time of the drying is ≥5 s.

13. The preparation method according to claim 12, wherein the temperature of the drying is 60° C. to 90° C.

14. A battery comprising: a positive electrode, a negative electrode, a separator disposed between the positive electrode and the negative electrode, and an electrolyte, wherein the separator is the battery separator according to any one of claims 1-7.
